(19) United States
(12) Patent Application Publication
(10) Pub. No.: US 2026/0172359 A1
(43) Pub. Date: Jun. 18, 2026

(54) SYSTEMS AND METHODS FOR FILTERING TRAFFIC

(71) Applicant: Infobip Ltd., London (GB)

(72) Inventors: Katarina KOVACIC, Zagreb (HR); Damir MILOTIC, Zagreb (HR); Matija RAŽEM, Zagreb (HR); Ian BARBARA, Madliena (MT); Dario FILIPOVIC, Zagreb (HR); Kwok Onn LOOI, Bandar Puteri (MY)

(73) Assignee: Infobip Ltd., London (GB)

(21) Appl. No.: 18/985,903

(22) Filed: Dec. 18, 2024

(51) Int. Cl. H04L 47/125; H04L 47/24; H04L 47/783

(52) U.S. Cl. CPC H04L 47/125; H04L 47/24; H04L 47/783

(57) ABSTRACT

Systems and methods for network communication degradation are disclosed. The system includes one or more processors configured to monitor network traffic associated with one or more devices to identify communication patterns. Upon detecting a predefined communication pattern in the monitored network traffic, the system generates a blocking event configured to degrade the network traffic associated with a specific application or service. The system implements the blocking event by instructing one or more network components to degrade the network traffic related to the specific application or service. This degradation reduces communication quality over a predefined temporal period.

### TECHNICAL FIELD

The present disclosure relates generally to the technical field of network traffic management. More particularly, the present disclosure relates to systems and methods for degrading communication traffic based on detected communication patterns to manage network resources and improve traffic management.

### BACKGROUND

Traditional methods of managing network traffic often focus on either broad traffic filtering or simplistic blocking mechanisms. These methods lack the sophistication needed to dynamically and precisely degrade traffic associated with specific applications or services based on real-time monitoring and detection of communication patterns. Consequently, they fail to optimize network resources effectively by targeting specific types of traffic.

This disclosure is directed to addressing challenges such as those mentioned above. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

The present disclosure addresses the technical problem(s) described above or elsewhere in the present disclosure and improves the state of data incident response techniques.

In some aspects, the techniques described herein relate to a computer-implemented method for degrading communication traffic, the method including: monitoring, by one or more processors, a network traffic associated with one or more devices; detecting, by the one or more processors, a predefined communication pattern in the monitored network traffic; upon detecting the predefined communication pattern, generating a blocking event, the blocking event configured to degrade the network traffic associated with a specific application or service; and implementing the blocking event by instructing one or more network components to degrade the network traffic associated with the specific application or service, wherein the degradation reduces a communication quality over a predefined temporal period.

In some aspects, the techniques described herein relate to a system including memory and one or more processors communicatively coupled to the memory, the one or more processors configured to: monitor a network traffic associated with one or more devices; detect a predefined communication pattern in the monitored network traffic; upon detecting the predefined communication pattern, generate a blocking event, the blocking event configured to degrade the network traffic associated with a specific application or service; and implement the blocking event by instructing one or more network components to degrade the network traffic associated with the specific application or service, wherein the degradation reduces a communication quality over a predefined temporal period.

In some aspects, the techniques described herein relate to one or more non-transitory computer-readable storage media including instructions that, when executed by one or more processors, cause the one or more processors to: monitor a network traffic associated with one or more devices; detect a predefined communication pattern in the monitored network traffic; upon detecting the predefined communication pattern, generate a blocking event, the blocking event configured to degrade the network traffic associated with a specific application or service; and implement the blocking event by instructing one or more network components to degrade the network traffic associated with the specific application or service, wherein the degradation reduces a communication quality over a predefined temporal period.

It is to be understood that both the foregoing general description and the following detailed description are example and explanatory only and are not restrictive of the detailed embodiments, as claimed.

### BRIEF DESCRIPTION OF THE DRAWINGS

The accompanying drawings, which are incorporated in and constitute a part of this specification, illustrate various example embodiments and together with the description, serve to explain the principles of the disclosed embodiments.

FIG. 1 is a diagram showing an example of a system environment, according to some embodiments of the disclosure.

FIG. 2A is a diagram depicting one or more components of a system, according to some embodiments of the disclosure.

FIG. 2B1 and FIG. 2B2 is a diagram depicting one or more components of a system, according to some embodiments of the disclosure.

FIG. 3 is a diagram depicting one or more components of a network architecture, according to some embodiments of the disclosure.

FIG. 4 is a diagram depicting one or more components of a network architecture, according to some embodiments of the disclosure.

FIG. 5 is a diagram depicting one or more components of a network architecture, according to some embodiments of the disclosure.

FIG. 6 is a diagram depicting one or more components of a network architecture, according to some embodiments of the disclosure.

FIG. 7 is a flowchart of a method of degrading communication traffic, according to some embodiments of the disclosure.

FIG. 8 shows an example machine-learning training flow chart, according to some embodiments of the disclosure.

FIG. 9 illustrates an implementation of a computer system that executes techniques presented herein, according to some embodiments of the disclosure.

### DETAILED DESCRIPTION

In some embodiments, the present disclosure pertains to the technical field of network traffic management. This disclosure encompasses techniques for monitoring, detecting, and degrading communication traffic based on identified communication patterns. Specifically, it introduces systems and methods configured to dynamically manage network traffic by generating and implementing blocking events that degrade traffic quality associated with specific applications or services. This approach leverages real-time data analysis to identify predefined patterns in network traffic, thereby enhancing network resource optimization and communication management. The disclosed techniques can be applied in various contexts, including mitigating unauthorized access attempts, managing network congestion, and ensuring efficient use of network resources.

Traditional approaches to network traffic management often rely on broad filtering or simplistic blocking mechanisms to manage communication traffic. These methods lack the granularity and sophistication needed to dynamically adjust network resources in response to real-time usage patterns. As a result, they may either over-block legitimate traffic or fail to adequately mitigate unwanted traffic, leading to inefficiencies and suboptimal network performance.

Traditional systems also face significant challenges in terms of managing communication traffic and network optimization. Specifically, when applications handle sensitive communications such as 2-Factor Authentication (2FA) requests, they often utilize non-optimized service providers and/or services, like Over-The-Top (OTT) services. These services are typically encrypted on the traffic delivery paths, preventing traditional monitoring systems from effectively identifying and managing the traffic, as the content of the messages is not readily accessible. Consequently, malicious actors can exploit these communication channels, bypassing short-message-service (SMS)-based measures and leading to potential breaches and unauthorized access. This exploitation may allow malicious actors to evade detection while interacting with the network and/or system, which may compromise the network and/or system, and may result in harm to the network and the end-users of the network.

Moreover, these traditional monitoring systems are often rigid and lack the flexibility to adapt to evolving network conditions or access based threats. This rigidity hinders their ability to implement advanced traffic management techniques or incorporate new measures without substantial manual intervention and updates. In the context of rapidly changing network environments and increasing cybersecurity threats, the inability to dynamically adjust network management protocols can significantly compromise the efficiency and management of network operations.

The use of OTT services for handling communication traffic, including 2FA requests, exacerbates these issues. OTT channels are encrypted, which not only prevent traditional monitoring systems from identifying and managing the traffic but also makes it difficult or impossible to understand user behavior. This lack of visibility into user behavior can present risks and degrade network performance. Network operators struggle to monitor and manage this traffic effectively that runs on their network assets, leading to potential access based vulnerabilities and inefficient network resource utilization.

Standalone implementation of OTT services in traffic communication presents limitations. These methods do not inherently provide the necessary granularity and control required to ensure efficient and secure traffic management. Consequently, relying solely on OTT services may not provide the optimal network performance, highlighting the need for advanced traffic management solutions that can dynamically monitor, detect, and degrade specific types of traffic based on real-time communication patterns.

To address concerns such as those mentioned above, the present disclosure provides systems and methods configured to monitor, detect, and degrade communication traffic based on identified communication patterns. By leveraging real-time data analysis, the system can dynamically generate and implement blocking events that degrade the traffic quality of specific applications or services. This targeted approach allows for more efficient network resource utilization by identifying one or more types of communication traffic and blocking the traffic of one or one more service, or causing that traffic to be diverted from one service to another service.

The proposed system employs a modular and flexible architecture that facilitates integration with existing network infrastructure, including traffic monitoring tools, firewalls, and other components. By decoupling the traffic management interface from the underlying network control logic, the system can readily adapt to changes in network conditions or operational requirements without necessitating extensive manual intervention or prolonged system downtime. This adaptability enables network operators to promptly respond to new challenges and optimize network performance.

A technical advantage of the present system lies in its ability to analyze metadata associated with network traffic, such as domain names, IP addresses, and timestamps, to identify communication patterns. By doing so, the system can detect predefined patterns that indicate specific applications or services. This detection capability allows the system to generate blocking events that degrade the traffic quality in a controlled and precise manner, reducing the bandwidth or increasing the latency for the targeted traffic. This granular control ensures that legitimate traffic is not unduly affected, while unwanted or potentially harmful traffic is effectively managed.

Another technical advantage is the system's ability to dynamically adjust the degradation of communication quality based on real-time monitoring of network traffic. By continuously analyzing the traffic patterns and adjusting the degree of degradation as needed, the system ensures optimal network performance. This dynamic adjustment reduces the risk of over-blocking legitimate traffic and ensures that the network can adapt to changing conditions and threats.

Additionally, the system enhances detection by generating alerts in response to detecting predefined communication patterns. These alerts include details of the detected patterns and associated devices, enabling network operators to take proactive measures to address potential detection criteria (e.g., triggered detection criteria). This proactive alerting mechanism, combined with the system's ability to degrade traffic quality, provides a robust framework for managing the desired network performance.

Furthermore, the system can identify specific applications or services based on destination IP addresses and port numbers associated with the network traffic. This identification allows the system to apply appropriate blocking events tailored to the specific application or service, ensuring that the degradation of traffic quality is precise and effective. By focusing on the traffic associated with particular applications or services, the system optimizes network resource utilization and enhances overall detection of potential detection criteria.

The system is also configured to detect certain types of high-priority messages, such as 2FA requests. Upon detecting these high-priority messages, the system can intentionally degrade traffic to one or more user devices associated with the communication patterns of OTT services. This intentional degradation encourages the redirection of 2FA messages to SMS communication channels, which are considered more reliable for delivering such sensitive information since the quality can be monitored by the Network Operators. By ensuring that 2FA messages are routed through SMS, the system enhances the reliability of the authentication process, and ensuring the timely delivery of critical authentication messages.

Furthermore, utilizing OTT services for 2FA can compromise the integrity of the possession factor in authentication protocols. While an OTT account may be linked to a user's MSISDN during the initial registration or onboarding process, the continued use of the OTT service does not necessitate the SIM card to remain in the device. Users can access OTT applications remotely or from devices that do not contain the original SIM card, undermining the assumption that possession of the device equates to possession of the SIM associated with the user's phone number. This disconnect weakens the benefits provided by the possession factor in 2FA, as unauthorized individuals might access the OTT account without physically possessing the user's device or SIM card. In contrast, SMS-based 2FA requires messages to be sent directly to the user's mobile number, ensuring that the possession factor remains intact since the SIM card must be present in the device to receive SMS messages. By promoting the use of SMS for 2FA, the system reinforces the authentication processes by reliably confirming the user's possession of the registered MSISDN.

The technical improvements and advantages discussed above are not the sole improvements and advantages, and additional technical improvements and advantages will be discussed in the following sections. Further, based on the present disclosure, other technical improvements and advantages will be apparent to one of ordinary skill in the art.

As an illustrative example, consider a practical application wherein a user attempts to access an online banking service that utilizes Two-Factor Authentication (2FA) for enhanced security. This scenario unfolds as follows: the user initiates a login request to the online banking service using a mobile banking app; simultaneously, the user has an OTT application, such as a messaging app, active on the device, which utilizes internet communications.

The system, equipped with one or more processors, monitors the network traffic associated with the user's device to identify communication patterns indicative of a 2FA request. Upon detecting a predefined communication pattern that matches the characteristics of a 2FA request, the system generates a blocking event. This blocking event is configured to degrade the network traffic quality associated with the messaging OTT application by either reducing the bandwidth or increasing the latency of the communication.

The degradation causes a temporary interruption or significant slowdown in the communication channel used by the messaging OTT application. As a result, the 2FA request by the online banking service, which is initially intended to be delivered via the messaging OTT application, fails to reach the user's device through this channel. The online banking service then automatically resends and reroutes the 2FA message to the user's registered SMS communication channel. The SMS channel, being more reliable, ensures that the 2FA message is promptly delivered to the user's mobile phone number.

The user receives the 2FA message via SMS, enters the received OTP into the online banking service's login interface, and successfully completes the authentication process. The system's ability to recognize the 2FA message pattern and intentionally degrade the messaging OTT application's communication channel ensures that the 2FA message is redirected to a more reliable SMS channel.

This example underscores the system's robustness in improving network performance. By dynamically monitoring network traffic, detecting specific communication patterns, and rerouting high-priority messages like 2FA requests to more reliable channels, the system effectively mitigates potential risks associated with OTT applications. Additionally, this approach ensures the timely and reliable delivery of critical authentication messages, and enhancing the overall user experience.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the disclosure is not to be considered as limited by the foregoing description.

Various non-limiting embodiments of the present disclosure will now be described to provide an overall understanding of the principles of the structure, function, and use of systems and methods disclosed herein for data extraction.

Reference to any particular activity is provided in this disclosure only for convenience and not intended to limit the disclosure. A person of ordinary skill in the art would recognize that the concepts underlying the disclosed devices and methods may be utilized in any suitable activity. For example, while the present disclosure is in the context of network management, one of ordinary skill would understand the applicability of the described systems and methods to similar tasks in a variety of contexts or environments. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” and/or “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

As used herein, a “brand” refers to any entity providing one or more applications that are eligible for processing within the system. This entity could be a company, organization, or individual developer that creates and distributes software applications. Brands may offer applications across various platforms, including web, mobile, and native applications, which require network access to function. The term encompasses both well-known corporations with multiple applications and smaller developers with a single offering. Brands are integral to the ecosystem as they supply the content and services that are subject to traffic monitoring and management.

As used herein, an “application” refers to any software program, whether web-based, mobile, native, or otherwise, that requires network access to perform its functions. Applications can range from simple mobile apps to complex enterprise software solutions. They may utilize various communication protocols to interact with backend services over the internet. Applications include, but are not limited to, social media platforms, banking apps, messaging services, and any other software that relies on network connectivity to deliver its features and functionalities.

As used herein, a “device” refers to any equipment capable of hosting an application. This includes, but is not limited to, smartphones, tablets, desktop computers, laptops, smartwatches, and IoT devices. Devices must have the necessary hardware and software components to run applications and connect to networks. The term also encompasses virtual devices, such as virtual machines or containers that can execute applications in a cloud computing environment. Devices serve as the end-user interface for interacting with applications and generating network traffic.

As used herein, “application services” refer to the network services required for a monitored application to function. These services include, but are not limited to, data storage, user authentication, messaging, API access, and any other backend services that applications need to operate. Application services typically utilize IP-based communication protocols to connect with applications over the internet. They may be provided by third-party vendors or hosted on proprietary servers.

As used herein, a “Data Services Provider (DSP)” refers to any Internet Service Provider (ISP) or equivalent entity that provides IP-based communication services. DSPs facilitate the transmission of data between devices and application services over the internet. They manage network infrastructure, ensure connectivity, and often provide additional services such as DNS resolution, bandwidth management. DSPs play a critical role in the overall network ecosystem by enabling seamless communication between end-users and applications.

As used herein, “Traffic Degradation Service (TDS)” refers to the proposed solution designed to monitor, detect, and degrade network traffic based on predefined communication patterns. The TDS system may comprise one or more hardware components, such as processors, memory modules, network interfaces, and storage devices, configured to execute the necessary functions for traffic monitoring and management. The system is configured to analyze network traffic in real-time, generate blocking events, and implement traffic degradation strategies.

The TDS may also utilize one or more machine-learning models to enhance its detection and response capabilities. These models can be configured to analyze large volumes of network data, identify complex traffic patterns, and predict potential threats. The TDS system may be further configured to train, update, and modify these machine-learning models to adapt to new patterns of network traffic and emerging threats. By continuously learning from real-time data, the TDS can improve its accuracy and effectiveness in managing network resources and enhancing communication delivery. This flexible and adaptive approach allows the TDS to be integrated with existing network infrastructure to provide granular control over network traffic.

As used herein, “IPs of Interest” refer to a set of IP (IPv4 or IPv6) addresses or IPs that are relevant to the solution in a given context. These IPs are selected based on their association with specific applications, services, or communication patterns that require monitoring and management. The set of IPs of Interest may differ from one TDS instance to another, depending on the targeted applications or services. Identifying and tracking IPs of Interest supports effective traffic filtering and monitoring within the TDS framework.

As used herein, “DNS Mapping” refers to a process of bidirectionally mapping domain names to a set of IP addresses. DNS Mapping involves translating human-readable domain names into machine-readable IP addresses and vice versa. This mapping is essential for routing network traffic to the correct destinations and for monitoring traffic patterns associated with specific domains. DNS Mapping enables the TDS system to recognize and manage traffic based on domain names, which can be more intuitive and flexible than managing traffic solely by IP addresses.

As used herein, “Traffic Patterns” refer to a set of recognized patterns of accessing IP addresses from an application that can trigger traffic blocking or degradation. Traffic Patterns are identified by analyzing the order, frequency, and timing of network requests made by an application. These patterns help the TDS system detect unusual or potentially harmful activities, such as unauthorized access attempts or data exfiltration. By recognizing and responding to specific Traffic Patterns, the system can maintain network optimization and performance.

As used herein, “Traffic Source” refers to the IP address of a device, MSISDN, or any other identifier that can be mapped to an IP address at any given moment. The Traffic Source represents the origin of network requests and supports tracking and managing traffic flows. Identifying Traffic Sources allows the TDS system to associate specific network activities with particular devices or users, enabling targeted traffic management.

As used herein, “Traffic Target” refers to IPs, domain names, or equivalent identifiers that can be associated with IP addresses that are either sources or destinations of IP packets, depending on the communication type. Traffic Targets correspond to application services and are used by the TDS system to identify the intended recipients of network requests. Managing Traffic Targets helps ensure that the right traffic is degraded or blocked, optimizing network resource utilization.

As used herein, “Traffic Time Component” refers to exact times, time spans, sliding windows, or any other representation of time aspects or equivalent model representation on the sequentially of monitored packets used in traffic pattern detection. The Traffic Time Component is essential for analyzing the timing of network activities and identifying patterns that occur within specific time frames. This temporal analysis helps the TDS system detect and respond to dynamic changes in network traffic.

As used herein, a “Monitor” refers to an instance of packet monitoring that monitors a certain subset of traffic and implements traffic pattern detection. Monitors are configured to analyze network packets in real-time, identify predefined traffic patterns, and generate appropriate blocking events. Each Monitor can be tailored to focus on specific types of traffic or communication patterns, providing granular control over network management.

As used herein, a “Sy Interface” refers to a communication interface between the Policy and Charging Rules Function (PCRF) and the Online Charging System (OCS) in a mobile network architecture. This interface is configured to facilitate the exchange of information related to user subscriptions and spending limits. The Sy Interface may utilize the Subscription-ID AVP (Attribute-Value Pair) as a means of user identification, which can be represented in various forms including, but not limited to, the Mobile Station International Subscriber Directory Number (MSISDN) for E.164 subscription types or the International Mobile Subscriber Identity (IMSI) for E.212 subscription types. In some implementations, multiple occurrences of the Subscription-ID AVP may be present to provide both IMSI and MSISDN information. The Sy Interface is configured to transmit the Subscription-ID within the Spending-Limit-Request command from the PCRF to the OCS when the SL-Request-Type is set to INITIAL_REQUEST. This interface is particularly useful in scenarios where Policy-Counter-Identifiers are provisioned against different traffic types, enabling the system to distinguish between grouped traffic towards international brands and grouped traffic towards OTT services used for bypass.

As used herein, a “Gx Interface” refers to a communication interface between the Packet Data Network Gateway (PGW) or Gateway GPRS Support Node (GGSN) and the Policy and Charging Rules Function (PCRF) in a mobile network architecture. This interface may be configured to facilitate the exchange of policy and charging control information. The Gx Interface utilizes the Subscription-ID AVP as a means of user identification, specifically in the form of the Mobile Station International Subscriber Directory Number (MSISDN) for E.164 subscription types. The Gx Interface is configured to transmit the Subscription-ID within the Credit-Control-Request command from the PGW/GGSN to the PCRF. This interface plays a critical role in enforcing policy rules and managing charging information for user sessions, ensuring that appropriate policies are applied based on the user's subscription and network conditions.

As used herein, a “Gy Interface” refers to a communication interface between the Packet Data Network Gateway (PGW) or Gateway GPRS Support Node (GGSN) and the Online Charging System (OCS) in a mobile network architecture. This interface may be based on the Ro interface specifications and may be configured to facilitate real-time charging control and credit management. The Gy Interface utilizes the Subscription-ID AVP as a means of user identification, specifically in the form of the Mobile Station International Subscriber Directory Number (MSISDN) for E.164 subscription types. The Gy Interface is configured to transmit the Subscription-ID within the Credit-Control-Request command from the PGW/GGSN to the OCS. This interface is particularly useful in scenarios where Rating-Groups are provisioned against different traffic types, allowing the system to distinguish between grouped traffic towards international brands and grouped traffic towards OTT services used for bypass. The Gy Interface enables the network to perform real-time charging and credit control, ensuring that users are billed accurately for their service usage and that credit limits are enforced in real-time.

As used herein, “detection criteria” may refer to one or more parameters and/or conditions utilized by the system to identify and respond to specific events, anomalies, or patterns within network traffic. These criteria may encompass one or both pre-determined rules and dynamically generated parameters that adapt to varying network conditions, evolving traffic patterns, emergent threats, and existing and new authentication methods. Detection criteria may include, but are not limited to, established protocols and thresholds based on known traffic patterns, authentication methods, real-time adaptive algorithms, machine learning models, heuristic analyses, temporal patterns of user activities, contextual information such as user location and device type, and correlations of activities that precede or follow events like the generation of 2FA messages.

Training a machine-learning model may include one or more machine-learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-Prototypes or K-Means may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc. After training the machine-learning mode, the machine-learning model may be deployed in a computer application for use on new input data that it has not been trained on previously.

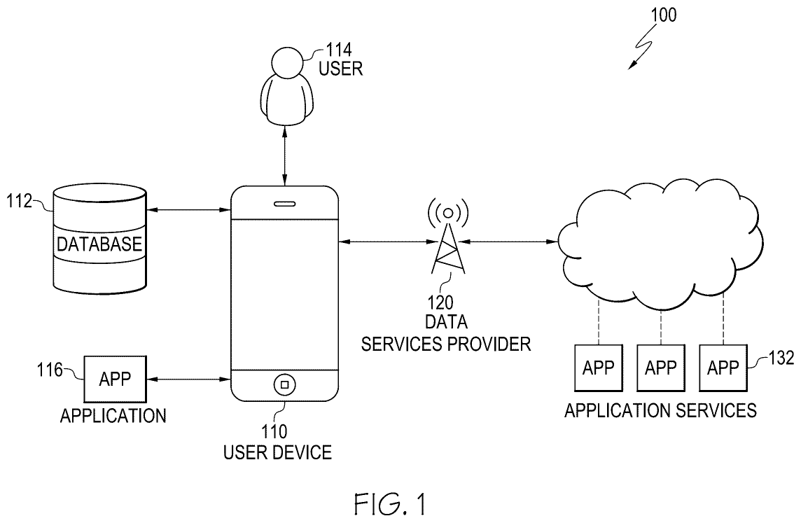

In some embodiments, FIG. 1 illustrates a diagram of a system configured for dynamic network traffic management and communication enhancement, in accordance with certain embodiments of the present disclosure. The depicted environment, labeled as environment 100, encompasses a communication infrastructure that facilitates connectivity among various components. These components include user devices 110, utilized by users to access applications and services; a database 112 that stores user-specific information and application data; an application 116 running on the user device; a data services provider (DSP) 120, configured for facilitating communication between user devices and application services; application services 130, which offer backend support and functionalities for the applications; and application instances 132, which are specific instances of applications hosted by the application services. This system is designed to monitor, detect, and manage network traffic dynamically, ensuring efficient resource utilization and enhanced communication.

In some embodiments, various components within environment 100 interact via a network facilitated by the data services provider 120. The data services provider 120 facilitates communication among multiple entities, including user device 110, which user 114 utilizes to access applications and services. The user device 110 is connected to database 112, which stores user-specific information such as application data and user preferences. The application 116 running on the user device communicates with application services 130, which provide backend support and functionalities for the applications. The data services provider 120 ensures that the user device 110 and application services 130 can exchange data seamlessly and securely. The network facilitated by the data services provider 120 may encompass various types of networks, including, but not limited to, data networks, wireless networks, telephony networks, or any combination thereof, to support robust and secure data exchange across environment 100. Within environment 100, any of these components may communicate with one another based on established access permissions, ensuring seamless and secure interaction throughout the system.

In some embodiments, any of the user devices 110, the database 112, and/or one or more other systems and/or databases associated with the data services provider 120 may contain a diverse collection of structured and/or unstructured data pertinent to user interactions, application performance, and network traffic patterns. This data, organized into one or more data objects, spans a variety of dimensions including user activity logs, application usage statistics, network performance metrics, API request and response data, compliance documentation, along with insights from data analytics. This extensive repository, which includes interaction records, performance data, traffic patterns, and the like, may be stored in storage solutions that range from local to cloud-based data storage systems, ensuring secure storage and accessibility for ongoing processing and analytical evaluation of network traffic.

One or more databases 112 may support the storage and retrieval of data related to one or more datasets and/or data objects, such as user activity logs, application usage statistics, network performance metrics, and API request and response data related to network traffic exchanges. The database stores metadata and operational data about entities represented in these datasets, as well as information received from the data services provider 120. The databases may comprise systems like a relational database management system (RDBMS), NoSQL database, or graph database, tailored to the specific needs and use cases within environment 100, particularly for managing the complex, interconnected data required for efficient network traffic management.

In some embodiments, the one or more databases, such as database 112 may embody any type of database system where data is systematically arranged in structures such as tables, graphs, or other suitable formats. The database is configured to store and facilitate retrieval of data utilized by one or more components of the environment 100, encompassing user activity logs, application usage statistics, network performance metrics, data relationships, and platform-generated outcomes. Furthermore, these databases maintain a vast array of information to aid in the analysis, prediction, and management of network traffic and access-related outcomes based on insights derived from user interactions within environment 100.

In some embodiments, one or more databases, such as database 112, comprise a machine learning-based analytics database outlining relationships, associations, and connections between input parameters from interaction data and application performance metrics, and output parameters representing network traffic management outcomes. This leverages machine learning algorithms to learn mappings between data inputs (e.g., interaction text, user attributes, application performance data) and outputs such as traffic management accuracy, application performance effectiveness, threat prediction, and correlations between interaction signals and network outcomes. This analytics database is periodically updated to incorporate additional insights from ongoing machine learning processes.

One or more components within environment 100 interact with other components within network facilitated by the data services provider 120 using established or evolving communication protocols. These protocols ensure efficient interactions between nodes and dictate conventions for creating, sending, and interpreting data exchanges across communication links. They operate across different layers, from generating physical signals to facilitating specific software applications engaged in transmitting or receiving data, enabling robust and secure data flow within environment 100 for comprehensive analysis at the intersection of user interactions and network management outcomes.

Communications between the various components of the networks are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers.

In some embodiments, environment 100 serves as a platform for managing and optimizing network traffic, utilizing techniques such as data analytics, artificial intelligence, and database management. For instance, environment 100 facilitates the generation of insights, metrics, and data objects from various datasets, including network traffic data, user interaction logs, and application performance statistics, according to predefined criteria or multiple parameters. This enables the system to dynamically monitor network conditions, detect anomalies, and implement traffic management strategies in real-time. The integration of advanced analytics and machine learning models allows environment 100 to continuously learn from network activities, improving its ability to predict and respond to potential threats and performance issues. By leveraging these technologies, environment 100 enables efficient resource utilization and enhances overall network communication and performance.

In some embodiments, the DSP 120 is configured to facilitate communication between user devices and application services. DSP 120 includes the one or more infrastructure component to support network connectivity, such as base stations, routers, switches, and other networking equipment. It is configured to ensure that data can flow seamlessly and securely between user device 110 and application services 130. DSP 120 manages data transmission, optimizes network performance, and provides additional services such as bandwidth management and traffic prioritization.

Application services 130 represent the backend services that support the functionality of applications running on user devices. These services may include data storage, user authentication, messaging, and other essential functions required by the applications. Application services 130 are hosted on servers and data centers, which may be distributed across multiple geographic locations to ensure reliability and scalability. They are configured to handle requests from multiple user devices simultaneously, providing the necessary resources to maintain application performance.

Within application services 130, there are one or more application instances 132. Each application instance 132 represents a specific deployment of an application, handling requests from user devices and interacting with the backend infrastructure. Application instances 132 are configured to scale based on demand, ensuring that resources are allocated efficiently to handle varying levels of traffic. These instances may be managed using containerization technologies or virtual machines, allowing for flexible and efficient resource management.

The data flow within the system involves several steps, starting from the user device 110 and extending to application services 130 through DSP 120. When user 114 interacts with application 116 on user device 110, data related to these interactions is transmitted to application services 130 via DSP 120. For instance, if user 114 initiates a request to fetch data, this request is sent from application 116 to DSP 120, which then routes it to the appropriate application instance 132 within application services 130.

Upon receiving the request, the relevant application instance 132 processes it by interacting with the necessary backend components, such as databases or other services, to fetch the required data. The processed data is then sent back through the same path, from application services 130 to DSP 120, and finally to user device 110, where it is displayed to user 114. This flow ensures that user 114 can access up-to-date information and interact with application 116 in real-time.

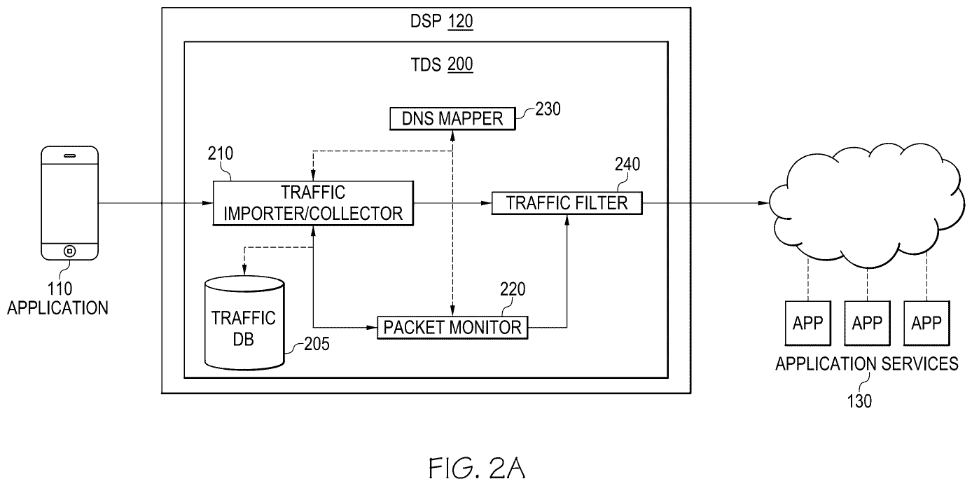

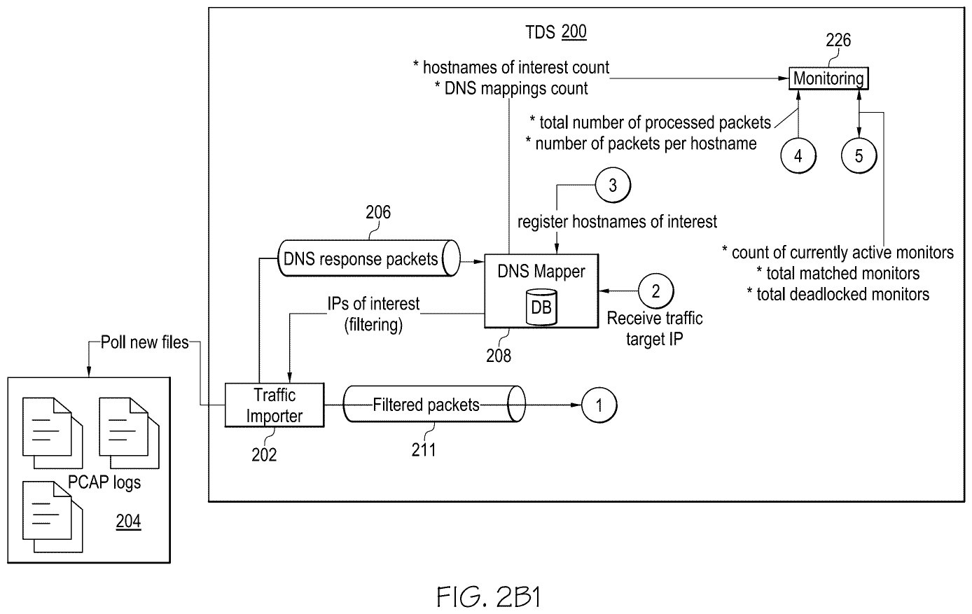

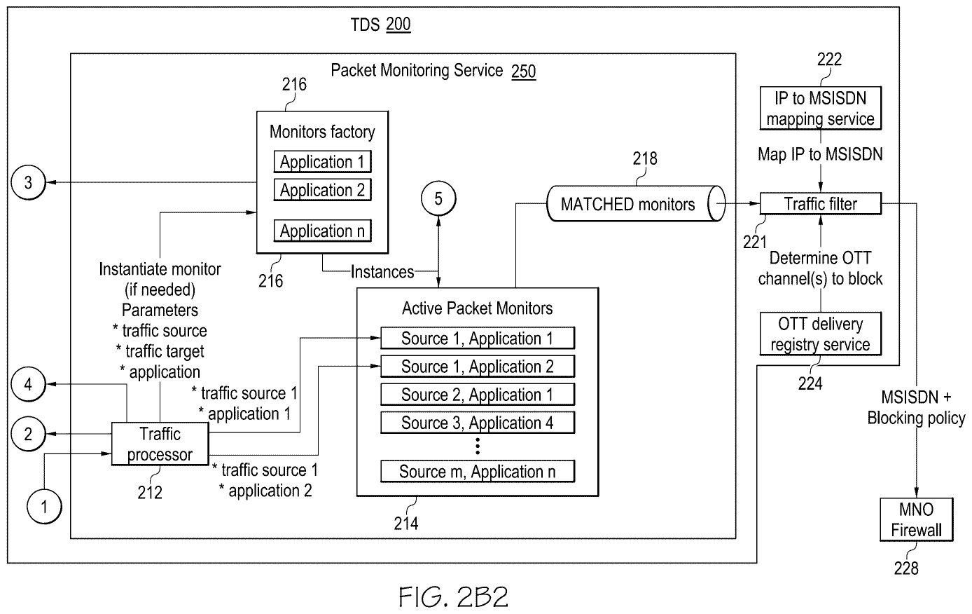

FIG. 2A illustrates a diagram depicting a data services provider (DSP) 120 and related components. DSP 120 is configured to encompass various components for monitoring, analyzing, and managing network traffic. Traffic Degradation Service (TDS) 200, which is configured to be a part of DSP 120, includes one or more components configured to perform specific functions in traffic management.

In some embodiments, traffic importer/collector 210 is configured to collect and filter traffic from user device 110. Traffic importer/collector 210 is configured to interface with traffic database (DB) 205, which is configured to store traffic data for analysis and future reference. Traffic importer/collector 210 is further configured to forward only relevant traffic for further analysis, thereby reducing the load on subsequent components. Traffic importer/collector 210 is configured to operate in either online or offline mode, where online mode involves active real-time reception of IP-based traffic, and offline mode involves receiving traffic from external DSP components in various forms such as network interfaces, PCAP files, CSV files, or other formats containing relevant data for processing.

In some embodiments, packet monitor 220 is configured to monitor the traffic patterns identified by traffic importer/collector 210. Packet monitor 220 is configured to analyze the traffic data to detect predefined communication patterns that may require traffic degradation. Packet monitor 220 is further configured to generate alerts and forward information to traffic filter 240 upon identifying such patterns. Packet monitor 220 is configured to operate on a stream of packets to detect traffic patterns and execute activities and/or notify other components of actions to be performed.

In some embodiments, DNS mapper 230 is configured to map domain names to IP addresses, aiding the identification of traffic sources and targets. DNS mapper 230 is configured to work in conjunction with traffic importer/collector 210 to provide accurate mapping data, which is utilized for effective traffic management. DNS mapper 230 is further configured to collect DNS mappings from traffic importer/collector 210 or by other means, such as periodically querying DNS for domains mapped to known IP addresses of interest. DNS mapper 230 is configured to track record liveness by removing inactive domain-IP address pairs and to provide inverse IP to domain mappings for use by packet monitor 220.

In some embodiments, traffic filter 240 is configured to implement traffic degradation strategies based on the information received from packet monitor 220. Traffic filter 240 is configured to reduce bandwidth, increase latency, or apply other degradation techniques to manage network traffic effectively. Traffic filter 240 is further configured to ensure application services 130 receive optimized and secure traffic from user device 110. Traffic filter 240 is configured to block traffic based on inputs from packet monitor 220, either by dropping IP packets based on a given set of rules or by setting such rules to external DSP components with such capabilities. Traffic filter 240 is configured to focus on narrowly degrading application usability on a specific device by dropping packets or performing equivalent actions on a device and application to a subset of IPs of interest channel.

In some embodiments, the data flow within this system is configured to begin with user device 110 sending traffic through DSP 120. Traffic importer/collector 210 is configured to collect and filter this traffic, storing relevant data in traffic DB 205. The filtered traffic is then analyzed by packet monitor 220 to identify any patterns that necessitate degradation. DNS mapper 230 is configured to assist in mapping domain names to IP addresses, providing data and/or a foundation for traffic management. Once patterns are identified, traffic filter 240 is configured to apply one or more degradation techniques.

In some embodiments, this configuration enables DSP 120 to dynamically manage network traffic, leveraging the capabilities of TDS 200 to enhance monitoring capabilities and performance. By integrating various components that monitor, analyze, and manage traffic, the system is configured to ensure efficient data flow and robust network management, addressing the challenges of modern network environments. The system is further configured to degrade OTT communication services to deliver 2FA messages when it detects that the end user may authenticate to one of the monitored applications. This degradation is achieved by monitoring traffic, detecting patterns, notifying traffic filter 240, mapping IP addresses to MSISDN, and generating rules for the relevant network nodes such as the operator firewalls to disable a subset of traffic from source to target IP for a configurable period of time.

FIG. 2B1 and FIG. 2B2 illustrate a diagram of the traffic degradation service (TDS) 200 and one or more components, according to some embodiments of the disclosure. TDS 200 is configured to manage network traffic through the DSP 120. TDS 200 is configured to encompass various modules and their interactions, focusing on the processes involved in monitoring, analyzing, and selectively degrading specific network traffic patterns. This configuration is configured to enhance network monitoring capabilities and performance by dynamically adjusting traffic based on real-time data analysis and predefined criteria.

In some embodiments, the data flow within TDS 200 is configured to begin with traffic importer 202. Traffic importer 202 is configured to import traffic data from various sources, including user device 110 and packet capture (PCAP) Logs 204. PCAP logs 204 are configured to store packet capture logs, providing a historical record of network traffic. Traffic importer 202 is further configured to aggregate incoming data and forward DNS response packets 206 to DNS mapper 208 for further processing. By collecting and organizing traffic data, traffic importer 202 is configured to serve as the initial point of entry for data into the TDS 200 system, ensuring that relevant traffic information is accurately captured and prepared for subsequent analysis.

In some embodiments, DNS mapper 208 is configured to map DNS response packets 206 to their corresponding domain names and IP addresses. DNS mapper 208 is further configured to process these packets to create accurate mappings, which are then stored in a database for future reference and analysis. Additionally, DNS mapper 208 is configured to identify IPs of interest from the DNS response packets, serving as a form of filtering to highlight relevant traffic sources and targets for further processing.

In some embodiments, DNS mapper 208 is configured to perform filtering based on pre-determined rules, specifying which IPs are of interest. In other embodiments, DNS mapper 208 is configured to utilize a dynamic algorithm to identify IPs of interest based on real-time analysis of the traffic data. This approach allows for more flexible and adaptive filtering, as the algorithm can adjust its criteria based on current network conditions and traffic patterns. In some embodiments, DNS mapper 208 is configured to utilize machine learning models to perform the filtering. This involves training a machine learning model on historical traffic data to recognize patterns and identify IPs of interest more accurately. The trained model is configured to filter incoming DNS response packets, continuously improving its accuracy and effectiveness as it processes more data. Once DNS mapper 208 has identified the IPs of interest, it is configured to pass this information back to traffic importer 202, ensuring that subsequent traffic processing focuses on the most pertinent data.

In some embodiments, filtered packets 211 are configured to be the result of the initial processing and filtering performed by traffic importer 202 and DNS mapper 208. These filtered packets are configured to contain traffic data that has been identified as relevant based on the filtering methods employed by DNS mapper 208. Filtered packets 211 are configured to represent the traffic data that is most pertinent for further analysis and processing within TDS 200.

In some embodiments, filtered packets 211 are configured to be passed to packet monitoring service 250, which is configured to monitor and analyze the traffic data. Packet monitoring service 250 is configured to comprise several subcomponents, including traffic processor 212, monitors factory 216, active packet monitors 214, and matched monitors 218.

In some embodiments, traffic processor 212 is configured to perform one or more analysis of the filtered packets 211. Traffic processor 212 is further configured to extract information about traffic patterns, sources, targets, applications, and destinations, enabling the identification of specific communication patterns and potential threats. Traffic processor 212 is configured to perform deep packet inspection and correlate the traffic data with known patterns of interest.

In some embodiments, monitors factory 216 is configured to instantiate packet monitors associated with one or more applications. These monitors are configured to provide one or more traffic analysis, such that the system can accurately identify and respond to relevant traffic patterns. Monitors factory 216 is further configured to dynamically create instances of packet monitors based on the parameters received from traffic processor 212, where each instance is a combination of one or more applications and one or more sources, such as a unique user device.

In some embodiments, active packet monitors 214 are configured to represent the active instances of packet monitors instantiated by monitors factory 216. These monitors are configured to continuously analyze the traffic patterns in real-time, detecting any anomalies or predefined patterns that may require further action. Active packet monitors 214 are further configured to provide ongoing surveillance of the network traffic, ensuring that any significant changes are promptly identified.

In some embodiments, active packet monitors 214 are further configured to analyze traffic patterns that include one or more temporally related user activities associated with the generation of 2FA messages. These activities may involve sequences or combinations of user actions that typically precede and/or follow a 2FA request, such as login attempts, password reset initiations, access to secure applications, or transactions requiring additional authentication. By employing advanced correlation algorithms and temporal analysis techniques, the system can identify patterns in user behavior that are indicative of an impending 2FA message generation. This correlation enables the system to anticipate and prepare for the detection of 2FA messages if and when delivered over the OTT channels, ensuring that the matching criteria are met for subsequent traffic filtering and blocking. Additionally, by analyzing activities that follow the generation of 2FA messages, the system can monitor for successful authentications over the desired SMS channel or detect potential anomalies that may signify threats.

In some embodiments, one or more machine-learning models are configured to enhance the functionality of active packet monitors 214 within packet monitoring service 250. These models are configured to be used by monitors factory 216 to generate and configure the active packet monitors. The application of machine learning is configured to allow for more sophisticated and adaptive monitoring of network traffic.

In some embodiments, one or more machine-learning models are configured to be trained on historical traffic data to recognize patterns indicative of various network conditions, including normal traffic flows, potential threats, performance issues, 2FA requests, and other events within the environment 100 (FIG. 1). The trained model is configured to be applied to active packet monitors 214, enabling them to detect complex patterns and anomalies that predefined rules might miss. This configuration enables more accurate and timely identification of traffic that requires further attention.

In some embodiments, one or more machine-learning models are configured to be used directly by monitors factory 216 to generate active packet monitors based on current network conditions and traffic patterns. By continuously learning from real-time data, the model is configured to dynamically adjust the parameters of the active packet monitors, ensuring that they are optimized for current traffic conditions.

In some embodiments, the one or more machine-learning models used by packet monitoring service 250 are configured to be periodically retrained to incorporate new traffic data and adapt to evolving network conditions. This retraining process is configured to involve updating the model with new data sets, refining its algorithms, and validating its performance against known traffic patterns. Additionally, the models are configured to be modified to include new features or improve existing ones, enhancing their ability to detect and respond to emerging threats and performance issues.

In some embodiments, one or more machine-learning models are configured to be employed to predict future network conditions based on historical data and current trends. These predictive capabilities are configured to inform the configuration of active packet monitors, allowing the system to proactively adjust its monitoring and management strategies.

In some embodiments, matched monitors 218 is configured to indicate the monitors that have identified traffic patterns matching the predefined criteria. When a match is found, matched monitors 218 is configured to generate alerts and provide the relevant information to other components within TDS 200 for further processing.

In some embodiments, packet monitoring service 250, through its subcomponents, is configured to provide comprehensive and continuous monitoring of network traffic. The insights gained from this monitoring are configured to be used to inform the subsequent traffic management actions performed by other components of TDS 200.

In some embodiments, monitors factory 216 is configured to register hostnames of interest based on the analysis performed by active packet monitors 214. When a hostname is identified as significant, monitors factory 216 is configured to update DNS mapper 208 with this information. This process involves monitors factory 216 communicating directly with DNS mapper 208 to add or modify entries related to the hostnames of interest.

In some embodiments, traffic processor 212 is configured to resolve traffic target IPs based on the analysis of filtered packets 211. When traffic processor 212 identifies relevant traffic target IPs, it is configured to update DNS mapper 208 with this information. This update process involves traffic processor 212 providing DNS mapper 208 with the resolved IP addresses associated with specific traffic targets.

In some embodiments, traffic filter 221 is configured to implement traffic degradation strategies based on the information received from packet monitoring service 250 and IP to MSISDN mapping service 222. Traffic filter 221 is further configured to process the traffic data and determine one or more actions to manage the traffic, such as reducing bandwidth, increasing latency, or blocking specific traffic flows. Traffic filter 221 is configured such that only permitted traffic is allowed to pass through while degrading or blocking traffic identified as non-essential or potentially harmful.

In some embodiments, IP to MSISDN mapping service 222 is configured to map IP addresses to MSISDNs (Mobile Station International Subscriber Directory Numbers). This service is configured to enable the identification of the device and user associated with specific traffic flows. IP to MSISDN mapping service 222 is further configured to provide information that informs the decisions made by Traffic filter 221, ensuring that traffic management strategies are accurately targeted. IP to MSISDN mapping service 222 is configured to be scalable and use distributed in-memory data grid systems, such as Redis, Hazelcast, or similar solutions, to efficiently store and manage the large volume of IP to MSISDN mappings.

In some embodiments, OTT delivery registry service 224 is configured to manage the delivery of services over OTT channels. This service is configured to maintain a registry of OTT delivery channels and ensure that traffic management policies are enforced across these channels. OTT delivery registry service 224 is further configured to interact with traffic filter 221 to apply the one or more traffic degradation strategies, ensuring that OTT traffic is appropriately managed. OTT delivery registry service 224 is configured to maintain a matrix of possible 2FA authentication methods for each application, enabling the system to generate appropriate firewall rules when traffic patterns are detected.

In some embodiments, MNO firewall 228 is configured to enforce the traffic management policies determined by traffic filter 221. MNO firewall 228 is further configured to act as a barrier between the mobile network and external networks, applying rules to control the flow of traffic based on the policies set by the system.

In some embodiments, monitoring 226 is a module configured to collect and analyze metrics related to the performance and operation of TDS 200. Monitoring 226 is further configured to track metrics such as the number of hostnames of interest, DNS mappings count, total number of processed packets, number of packets per hostname, count of currently active monitors, total matched monitors, and total deactivated monitors. These metrics are configured to provide insights into system performance, identify possible issues, and enable timely reactions and adaptations. Monitoring 226 may be implemented using existing solutions such as Prometheus, Grafana, Alertmanager, or similar systems that offer collection of metrics, visualization, and alerting capabilities.

In some embodiments, TDS 200 is configured to implement traffic pattern matching through various methods, including state machines and rolling windows. State machines are configured to be used for more deterministic patterns, tracking the sequence of domain accesses for each combination of traffic source and application. Rolling windows are configured to be implemented as a series of time-based buckets, tracking accessed domains over short intervals. These implementations are configured to be mixed, providing flexibility in pattern detection while maintaining a consistent interface.

In some embodiments, traffic patterns are configured to be formed based on any combination of traffic source, traffic target, application, time component, or other parameters that may affect the precision of traffic pattern detection. Monitors are configured to be implementations of traffic pattern matching that are instantiated based on a combination of these parameters.

In some embodiments, TDS 200 is configured to employ machine learning for pattern and anomaly detection. The system is configured to collect inbound traffic data, end-user complaints, and manually detected patterns to train models for identifying new patterns and reducing false positive results. Anomaly detection models are configured to be used to automate monitoring and alerting, dynamically generating thresholds based on historical time-series data of system metrics.

In some embodiments, TDS 200 is configured to provide a scalable and efficient solution for managing network traffic, particularly in scenarios involving 2FA and OTT communications. The system is further configured to adapt to changing application behaviors, employ sophisticated monitoring techniques, and utilize machine learning to enhance its effectiveness in identifying and managing traffic patterns.

In some embodiments, TDS 200 is configured to operate in an offline mode, reading PCAP files as input. This configuration allows for detailed analysis of historical traffic data and enables the system to process large volumes of data without impacting real-time network performance. In some embodiments, the reliability and effectiveness of TDS 200 are configured to be maintained through a feedback loop that accounts for potential changes in Application implementations. This feedback loop is configured to utilize the monitoring and alerting capabilities of the system to track relevant indicators and adjust the system's behavior accordingly. In some embodiments, TDS 200 is configured to provide a comprehensive solution for network traffic management, combining real-time analysis, machine learning, and adaptive strategies to ensure efficient data flow, and optimized network performance in modern, complex network environments.

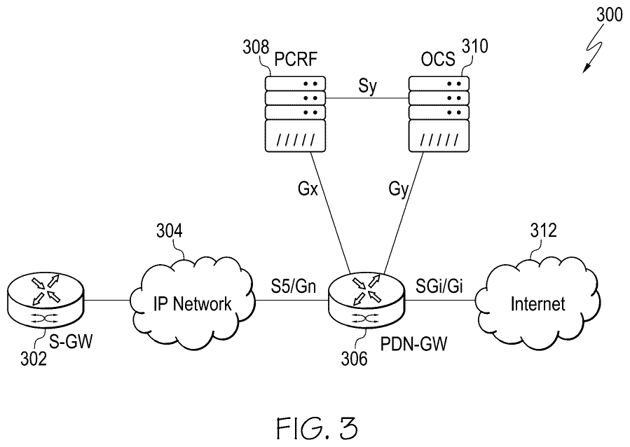

In some embodiments, FIG. 3 illustrates a diagram of network architecture 300, depicting the components and their interactions within a mobile network, in accordance with certain embodiments of the present disclosure. This architecture includes one or more components configured to facilitate network connectivity and data management. In some embodiments, S-GW 302, or Serving Gateway, is configured to route and forward user data packets within the mobile network. It serves as a local mobility anchor point during handovers between eNodeBs (base stations) and provides connectivity between the user equipment and the packet data network gateway (PDN-GW 306). In some embodiments, IP network 304 is configured to provide the infrastructure for routing IP-based communication between network components. This network facilitates the transmission of data packets from S-GW 302 to PDN-GW 306, ensuring efficient and reliable communication within the mobile network.

In some embodiments, PDN-GW 306 is configured to serve as the interface between the mobile network and external networks, such as internet 312. PDN-GW 306 provides connectivity to the internet, managing the flow of data packets between the mobile network and external networks. It also enforces quality of service (QoS) policies and performs other critical functions, such as IP address allocation and mobility management.

In some embodiments, PCRF 308, or policy and charging rules function, is configured to manage policy control and charging rules within the network. PCRF 308 communicates with PDN-GW 306 over an interface, such as the Gx interface, providing real-time policy decisions based on user subscriptions, service requirements, network conditions, and the like. PCRF 308 is configured such that network resources are allocated according to predefined policies and that users are charged appropriately for their data usage. In some embodiments, OCS 310, or online charging system, is configured to handle real-time charging and billing processes. OCS 310 communicates with PDN-GW 306 over the Gy interface, monitoring data usage and applying relevant charges based on user activity. OCS 310 is configured to enable accurate billing and supports various charging models, such as prepaid and postpaid accounts. In some embodiments, internet 312 represents the external internet connection, providing access to global internet services. PDN-GW 306 manages the data flow between the mobile network and internet 312, ensuring secure and efficient connectivity for users.

In some embodiments, the data flow within network architecture 300 begins with user data packets originating from user equipment (such as a user device) and being routed through S-GW 302. S-GW 302 serves as a local mobility anchor and forwards the data packets to IP network 304. IP network 304 provides the infrastructure for routing these packets to PDN-GW 306. PDN-GW 306 acts as the interface between the mobile network and external networks, such as Internet 312. As data packets reach PDN-GW 306, it manages their flow to and from Internet 312, ensuring that the packets are routed correctly and efficiently between the mobile network and the global internet.

In some embodiments, policy control and charging are managed in real-time as part of the data flow. PCRF 308 communicates with PDN-GW 306 over the Gx interface to provide policy decisions based on user subscriptions and service requirements. This communication enables network resources to be allocated according to one or more predefined policies. Simultaneously, OCS 310 handles real-time charging and billing processes by communicating with PDN-GW 306 over the Gy interface. OCS 310 monitors data usage and applies relevant charges based on user activity. This integrated approach ensures that the data flow is not only efficient and secure but also compliant with policy and charging rules, providing a seamless experience for users.

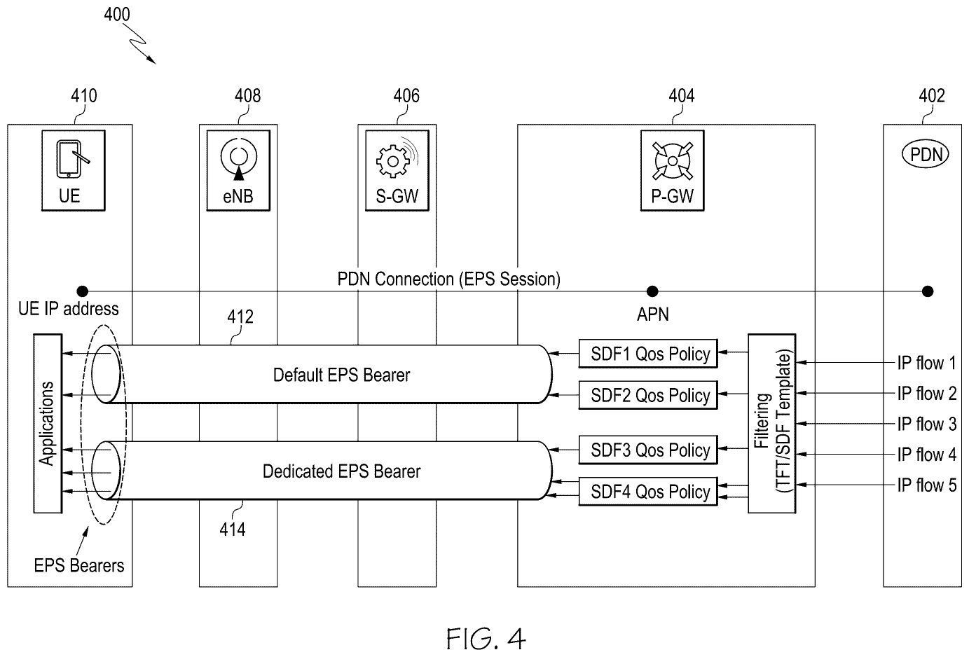

FIG. 4 illustrates a diagram of network architecture 400, depicting the components and their interactions within an EPS (evolved packet system) session, in accordance with certain embodiments of the present disclosure. This architecture facilitates network connectivity and data management through a series of interconnected elements that manage the flow of data packets.

In some embodiments, user equipment (UE) 410, which is any mobile device such as a smartphone or tablet, initiates data sessions and connects to the mobile network by communicating with an evolved Node B (eNB) 408. The eNB 408 serves as the base station, providing the radio interface between the UE 410 and the mobile network. Once the data packets are transmitted from UE 410, they are forwarded to the serving gateway (S-GW) 406. The S-GW 406 is configured for routing and forwarding the user data packets within the mobile network, acting as a local mobility anchor during handovers between eNBs 408. This ensures continuous connectivity as the user moves, physically. From S-GW 406, the data packets are routed to the packet data network gateway (P-GW) 404. P-GW 404 serves as the interface between the mobile network and external networks, such as the packet data network (PDN) 402. It manages the flow of data packets between the mobile network and PDN 402.

In some embodiments, within this architecture, a PDN connection (EPS session) is established, which includes a default EPS bearer 412 and one or more dedicated EPS bearers 414. The default EPS bearer 412 provides the initial bearer for a data session, establishing a basic level of service for data transmission. It is automatically established when the UE attaches to the network and provides a default gateway to the PDN. Dedicated EPS bearers 414, on the other hand, are configured to provide higher and/or lower quality of service (QoS) for specific applications. These bearers are set up in addition to the default bearer and are used for applications that require guaranteed bandwidth or low latency, such as video streaming or voice over IP (VoIP). Each dedicated bearer is associated with a specific QoS policy, which ensures that the necessary network resources are allocated to maintain optimal performance for the application. The QoS policies for each service data flow (SDF) are managed through the SDF QoS policy templates. These templates define the filtering rules (TFT/SDF templates) that determine which IP flows are directed through each bearer. For example, IP flow 1 might be directed through a bearer with high bandwidth, while IP flow 2 might go through a bearer optimized for low latency. In some embodiments, one or more EPS bearer may be configured for degraded performance, such as discussed throughout. The data flow within this architecture is configured such that user data packets are efficiently routed from the UE 410, through the eNB 408, S-GW 406, and P-GW 404, to the PDN 402. The use of default and dedicated EPS bearers allows for flexible and optimized management of network resources, ensuring that different types of data flows receive the desired level of service quality. This architecture supports a variety of applications and services, maintaining high performance and reliability across the mobile network.

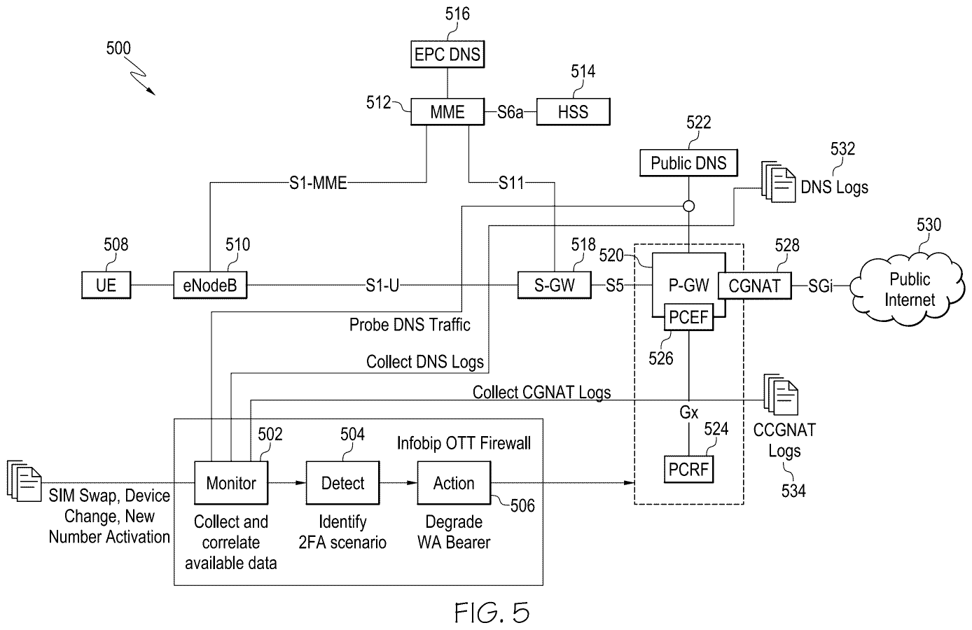

FIG. 5 illustrates a diagram of network architecture 500, according to some embodiments of the disclosure. FIG. 5 depicting one or more components and their interactions within a network architecture 500, such as a mobile network, and their relation to one another in monitoring, detecting, and taking action to manage network traffic based on detected events. This architecture is configured to handle events such as the initiation of a 2FA process or other events, and subsequently degrade service to one or more OTT applications based on the detected event. It will be appreciated that while network architecture 500 is described using specific components, the techniques and embodiments discussed herein are applicable to a wide range of network architectures. These include, but are not limited to, 5G networks, next-generation networks, and other communication systems with equivalent functionalities.

In some embodiments, a monitoring stage within network architecture 500 is configured to collect and correlate data. User equipment (UE) 508 initiates data sessions, connecting to the network through an evolved Node B (eNodeB) 510, which serves as the base station providing the radio interface. The mobility management entity (MME) 512 and the home subscriber server (HSS) 514 manage user sessions and subscriber information respectively. The evolved packet core DNS (EPC DNS) 516 and the serving gateway (S-GW) 518 route and manage data traffic.

In some embodiments, the monitor 502 is configured to collect and correlate data from various sources. This may include probing DNS traffic through EPC DNS 516 and/or public DNS 522, using public DNS logs 532, and/or collecting Carrier-Grade Network Address Translation (CGNAT) logs 534. Monitor 502 may also collect data from the Gx and Gy interfaces when Authentication, Authorization, and Accounting (AAA) traffic is not available, receiving and/or generating one or more UE IP to MSISDN mapping. Monitor 502 may also monitor events like SIM swaps, MSISDN changes, new number activations, and device changes to focus on traffic from specific UEs and correlate traffic with one or more different data identifier with one or more specific UE. The gathered data provides a view of the network activity, enabling accurate monitoring of events such as those that may typically lead to the generation of 2FA messages.

In some embodiments, a detecting stage involves the detect 504 component, which is configured to identify specific events, such as the initiation of a 2FA process. Detect 504 analyzes the data collected and correlated by monitor 502 to identify patterns indicative of such events. This detection enables the system to recognize one or more events, such as new users onboarding scenarios and other significant events, which may require network intervention in the form of applying one or more action.

In some embodiments, the action stage involves the action 506 component, which is configured to degrade service to one or more network attributes based on the detected event. For example, upon detecting a 2FA process initiation, action 506 degrades the dedicated bearer for an OTT traffic service. The action 506 component uses one or more network interface to communicate with the policy and charging rules function (PCRF) 524. This communication may be implemented using the REST-Rx (RESTful HTTP and XML as specified in 3GPP TS 29.201) or Rx (DIAMETER based) protocols. By interacting with PCRF 524, action 506 dynamically adjusts the quality of service and applies traffic management policies to degrade specific traffic types, such as 2FA. The result of this degradation may be that a particular message, such as a 2FA message, is routed to SMS channels.

The overall data flow within network architecture 500 involves one or more interactions between the components. User data packets flow from UE 508 to eNodeB 510 and are managed by MME 512 and HSS 514 for session and subscriber management respectively. Data is then routed through S-GW 518 to P-GW 520 over the S1-U, S5, and SGi interfaces, which interfaces with public DNS 522 and public internet 530. The policy and charging enforcement function (PCEF) 526 and carrier grade network address translation (CGNAT) 528 manage policy enforcement and address translation, respectively.

Throughout this process, logs such as DNS logs 532 and CGNAT logs 534 are collected and analyzed by monitor 502. Monitor 502 identifies relevant traffic patterns and updates detect 504 to recognize events such as the initiation of a 2FA process. When such an event is detected, action 506 communicates with PCRF 524 to apply the necessary traffic management policies, degrading service to one or more OTT applications as required. This integrated approach ensures that the network can dynamically respond to detected events, maintaining performance by managing and optimizing traffic flows.

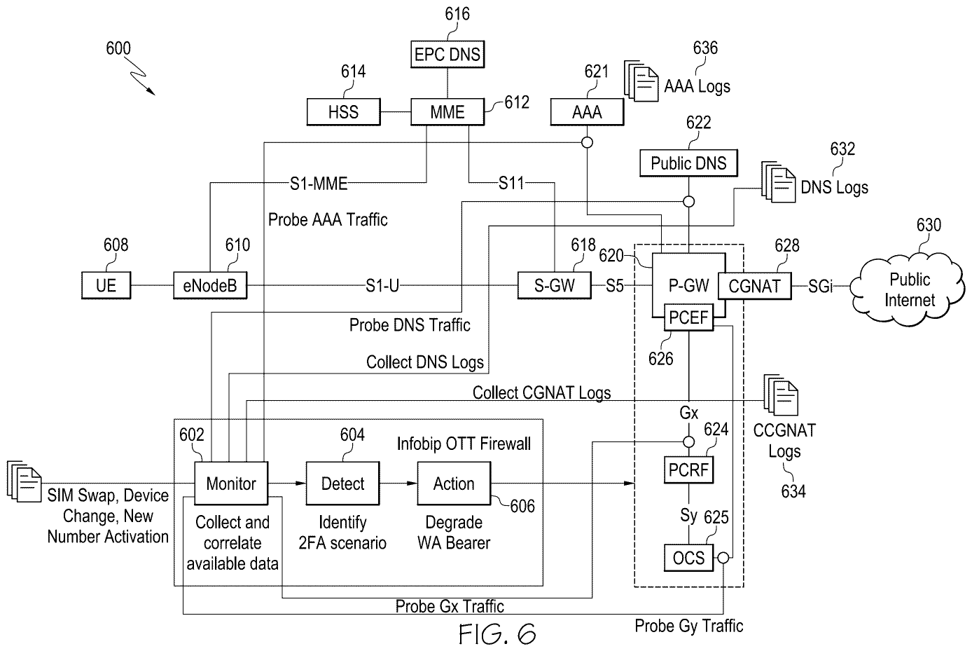

In some embodiments, FIG. 6 illustrates a diagram of network architecture 600, according to some embodiments of the disclosure. FIG. 6 depicts one or more components and their interactions within a network architecture 600, such as a mobile network, configured for monitoring, detecting, and taking action to manage network traffic based on detected events. This architecture is configured to handle events such as the initiation of a 2FA process or other events, and subsequently degrade service to one or more OTT applications based on the detected event.

In some embodiments, a monitoring stage within network architecture 600 involves is configured to collect and correlate data. User equipment (UE) 608 initiates data sessions, connecting to the network through an evolved Node B (eNodeB) 610, which serves as the base station providing the radio interface. The mobility management entity (MME) 612 and the home subscriber server (HSS) 614 manage user sessions and subscriber information respectively. The evolved packet core DNS (EPC DNS) 616 and the serving gateway (S-GW) 618 route and manage data traffic.

In some embodiments, the monitor 602 is configured to collect and correlate data from various sources. Monitor 602 is configured to probe DNS traffic through EPC DNS 616, using public DNS logs 632, and collecting CGNAT logs 634. Monitor 602 also collects data from the AAA component 621 and one or more associated AAA logs 636, which provide authentication, authorization, and accounting information. Additional data sources may include the Gx and Gy interfaces, allowing for comprehensive monitoring of network activity. Monitor 602 correlates this data to map UE IP addresses to MSISDNs, using interfaces such as AAA traffic, Gx, and Gy interfaces when AAA is not available. It also monitors events such as SIM swap, MSISDN change, new number activation, and device changes to focus on traffic from specific UEs. The gathered data provides a comprehensive view of the network activity, enabling accurate monitoring of events, such as those that may typically lead to the generation of 2FA messages.

In some embodiments, the detecting stage involves the detect 604 component, which is configured to identify specific events, such as the initiation of a 2FA process. Detect 604 analyzes the data collected and correlated by monitor 602 to identify patterns indicative of such events. This detection ensures that the system can recognize sensitive scenarios and other events that may require network intervention.

In some embodiments, the action stage involves the action 606 component, which is configured to degrade service to one or more OTT applications based on the detected event. For example, upon detecting a 2FA process initiation, action 606 degrades the dedicated bearer for an OTT traffic service. The action 606 component uses the Rx interface to communicate with the policy and charging rules function (PCRF) 624. This communication may be implemented using the REST-Rx (RESTful HTTP and XML as specified in 3GPP TS 29.201) or Rx (DIAMETER based) protocols. By interacting with PCRF 624, action 606 dynamically adjusts the quality of service and applies traffic management policies to degrade specific traffic types, ensuring that the network remains secure and optimized.

The overall data flow within network architecture 600 involves several interactions between the components. User data packets flow from UE 608 to eNodeB 610 and are managed by MME 612 and HSS 614 for session and subscriber management respectively. Data is then routed through S-GW 618 to P-GW 620 over the S1-U, S5, and SGi interfaces, which interfaces with Public DNS 622 and Public Internet 630. The policy and charging enforcement function (PCEF) 626 and carrier grade network address translation (CGNAT) 628 manage policy enforcement and address translation, respectively. Additionally, the online charging system (OCS) 625 is configured for real-time charging and billing processes, ensuring accurate and timely billing based on user activity.

In some embodiments, throughout this process, logs such as DNS logs 632, CGNAT logs 634, and AAA logs 636 are collected and analyzed by monitor 602. Monitor 602 identifies relevant traffic patterns and updates detect 604 to recognize events such as the initiation of a 2FA process. When such an event is detected, action 606 communicates with PCRF 624 to apply the necessary traffic management policies, degrading service to one or more OTT applications as required. This integrated approach ensures that the network can dynamically respond to detected events, maintaining performance by managing and optimizing traffic flows.

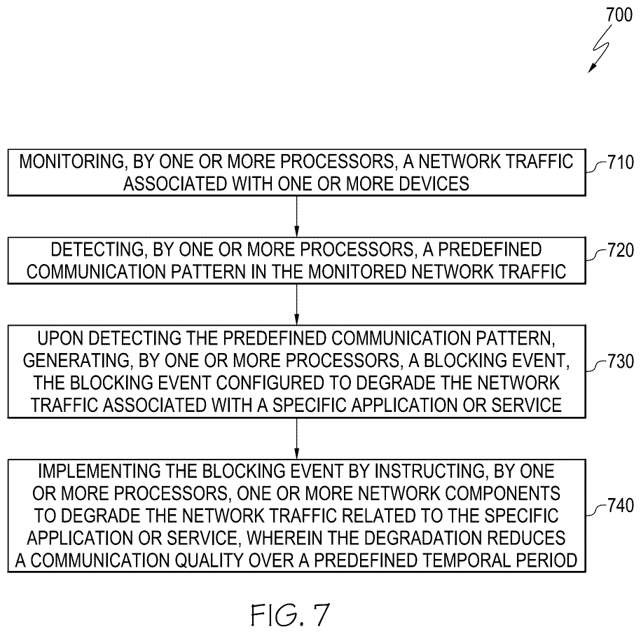

FIG. 7 is a flowchart depicting steps in a method 700 for degrading communication traffic. In some embodiments, method 700 is a computer-implemented method, which includes step 710, monitoring, by one or more processors, network traffic associated with one or more devices to identify communication patterns. This monitoring involves capturing data packets from user devices as they interact with various network services and applications. Monitoring can be performed continuously or at specified intervals to ensure real-time data capture, as desired.

In some embodiments, the monitoring further comprises analyzing metadata associated with the network traffic to identify the one or more communication patterns. The metadata may include one or more of one or more domain names, one or more IP addresses, one or more timestamps, or the like, associated with the network traffic. Metadata analysis involves parsing the data packets to extract relevant information such as domain names, IP addresses, and timestamps. Domain names provide context about the services or applications being accessed. IP addresses help identify the source and destination of the traffic, which may assist in enabling mapping user interactions. Timestamps allow the system to understand the timing and sequence of events, which may assist in enabling detecting patterns over time. The analysis process can use pattern recognition algorithms to detect communication patterns indicative of specific user activities and/or events within the network environment.

In some embodiments, the monitoring includes collecting DNS records by brand, timestamp, and/or counter. DNS records are collected to track the resolution of domain names to IP addresses, providing insights into user interactions with different services. Brand-specific DNS records help in associating traffic with particular applications or services. The timestamp indicates when the DNS query occurred, allowing the system to correlate it with other network activities. Counters can be used to track the frequency of DNS queries for specific domains, which may indicate repeated access or attempted access to certain services.

In some embodiments, the monitoring includes establishing thresholds between DNS occurrences on a single brand-MSISDN pair that will trigger degradation. A threshold is defined for the number of DNS queries for a particular brand and MSISDN pair within a specific time frame. When the threshold is exceeded, it indicates unusual or potentially significant activity, triggering further analysis or action. This threshold helps in distinguishing normal user behavior from patterns that may require intervention, such as triggered detection criteria or high-priority events.

In some embodiments, the monitoring includes filtering IP packets based on IP ranges to ignore one or more sources of traffic being monitored within the network. Filtering is performed to reduce the volume of data that needs to be processed, focusing only on relevant traffic, which may be defined as traffic which is considered likely to be associated with one or more target event. IP ranges associated with known services or applications are used to filter out irrelevant traffic. This step ensures that the system's resources are used efficiently, processing only the data that is likely to contain useful information.

In some embodiments, the monitoring includes using Equipment Identity Register (EIR) data to identify one or more changes to a user and/or a user device within the network, such as SIM card changes and new devices. SIM card changes and new device activations are events that may indicate new user behavior. By monitoring these changes, the system can adjust its analysis and detection strategies accordingly. Moreover, the system is configured to identify such changes and record the changes to one or more logs, which may update the logs and/or one or more records associated with a user, user device, application, or the like.

In some embodiments, the monitoring includes correlating user actions within applications to network traffic patterns. The system is configured to identify specific user actions, such as initiating a 2FA process, based on the observed network traffic patterns. While encryption may limit the visibility of exact user actions, certain patterns can still be detected based on metadata and timing. This correlation helps to identify events that are likely to trigger the degrade events or require network interventions, such as one or more actions.

In some embodiments, the identification of actions or network events is configured to occur by matching traffic patterns to one or more pre-defined traffic patterns. These pre-defined patterns can be uploaded or defined by an administrator of the system. The administrator can specify patterns that are indicative of specific user actions or events, such as accessing certain domains in a specific sequence or generating a specific number of DNS queries within a defined time frame. The system is configured to compare real-time network traffic against these pre-defined patterns to identify matching events. This approach allows for customized monitoring based on the unique requirements and characteristics of the network and its users.

In some embodiments, the system includes one or more machine-learning models that are trained to identify one or more network events. These models are trained using historical network traffic data, which includes labeled instances of various user actions and events. The training process involves using supervised learning techniques to teach the models to recognize patterns in the data that correspond to specific events. Once trained, the machine-learning models can analyze real-time network traffic to detect events that match the learned patterns. This approach enables the system to adapt to new and evolving traffic patterns, improving its accuracy and effectiveness over time.

In some embodiments, the machine-learning models are configured to be updated and retrained periodically to maintain their accuracy. The system collects new network traffic data continuously, and this data is used to retrain the models at regular intervals. Retraining ensures that the models remain effective at identifying relevant events, even as network traffic patterns change over time. The system may also incorporate feedback from administrators and end-users to refine the models further, enhancing their ability to detect specific actions or events.

In some embodiments, the system is configured to use a combination of pre-defined traffic patterns and machine-learning models to identify actions or network events. This hybrid approach leverages the strengths of both methods, using predefined patterns for well-understood and predictable events, and machine-learning models for more complex and dynamic patterns. By combining these techniques, the system can achieve a high level of accuracy and flexibility in monitoring network traffic and identifying significant events.

In some embodiments, the system employs a rolling window concept to monitor network traffic patterns. A rolling window consists of multiple buckets, each representing a fixed time unit, such as one second. The system collects traffic data in these buckets, with each bucket holding all traffic targets (e.g., domains) accessed during its time unit. As time progresses, the active bucket rotates at regular intervals, clearing previous values and updating with new data. This method enables the system to maintain a sliding view of recent network activity, allowing it to detect patterns within a specified time frame. The rolling window is particularly effective for identifying short-term patterns and transient behaviors in network traffic, as it continuously updates and analyzes recent data.

In some embodiments, the system allows administrators to define new traffic patterns and upload them into the system. These patterns are then incorporated into the monitoring process, providing a customizable and adaptable solution for identifying network events. In some embodiments, the system includes a user interface that allows administrators to review and manage the pre-defined patterns and machine-learning models. This interface provides tools for visualizing network traffic, reviewing detected events, and adjusting the parameters of the monitoring process.

In some embodiments, the method further includes monitoring data points such as DNS traffic, IP addresses, timestamps, SIM card changes, device changes, and user action patterns. The method also includes filtering traffic based on IP ranges and relevant packets, as well as setting thresholds and alerts for DNS query occurrences and anomaly detection.

In some embodiments, method 700 further includes step 720, detecting, by one or more processors, a predefined communication pattern in the monitored network traffic. Detection involves analyzing the captured network traffic to identify specific patterns that match predefined criteria. The predefined communication patterns are configured to represent significant events or user actions, such as the initiation of a 2FA process or other sensitive activities.

In some embodiments, the predefined communication pattern comprises a sequence of network addresses accessed by the one or more devices, and the sequence is identified by analyzing an order and frequency of network addresses accessed within a specified time frame. In some embodiments, the system analyzes the order and frequency of network addresses accessed by one or more user devices. The sequence may indicate a specific user action, such as logging into an application, accessing multiple related services, the initiation of a 2FA process, or the like. By tracking the order and frequency, the system can detect patterns that suggest a predefined communication event.

In some embodiments, the predefined communication pattern is identified based on a temporal correlation of network traffic events. Temporal correlation involves analyzing the timing and sequence of network events to detect patterns. The system compares the timestamps of network events to identify patterns that occur within a specific time frame. Temporal correlation helps in identifying patterns that are dependent on the timing of events, such as consecutive access to certain domains within a short period.

In some embodiments, the predefined communication patterns are defined by an administrator of the system. Administrators can define patterns based on known network events, user behaviors, or specific events of interest. The system allows administrators to upload and manage these predefined patterns, such as by updating one or more database and/or component of the system, such that the detection criteria are up-to-date and relevant. Defined patterns can include sequences of one or more IP addresses, domain names, or specific behaviors that indicate risks or user actions.

In some embodiments, one or more machine-learning models are trained to identify predefined communication patterns. Machine-learning models are trained using historical network traffic data, which includes labeled instances of various user actions and events. The training process involves supervised learning techniques to teach the models to recognize patterns that correspond to specific events. Once trained, the models analyze real-time network traffic to detect events that match the learned patterns. In some embodiments, the machine-learning models are periodically updated and retrained to maintain their accuracy. The system continuously collects new network traffic data, which is used to retrain the models at regular intervals. Retraining ensures that the models remain effective at identifying relevant events, even as network traffic patterns change. The system may also incorporate feedback from administrators and end-users to refine the models further.

In some embodiments, the system uses a combination of predefined communication patterns and machine-learning models to detect events. This hybrid approach leverages the strengths of both methods, using predefined patterns for well-understood events and machine-learning models for more complex patterns. Combining these techniques enhances the system's ability to accurately detect a wide range of events and user actions.

In some embodiments, the system includes an interface that allows administrators to review and manage predefined patterns and machine-learning models. The interface provides tools for visualizing network traffic, reviewing detected events, and adjusting the parameters of the detection process. Administrators can use the interface to update patterns, retrain models, and ensure that the detection criteria are aligned with current security and operational requirements.

In some embodiments, the method 700 further includes step 730, where upon detecting the predefined communication pattern, the system is configured to generate a blocking event, which may be generated by one or more processors. The blocking event is configured to degrade the network traffic associated with a specific application or service, ensuring that the detected pattern triggers one or more desired network management actions.

The blocking event may be configured in several ways to achieve the desired traffic degradation. One approach involves reducing the bandwidth available to the specific application or service, thereby limiting the data transfer rate and slowing down the application's performance. Another approach involves increasing the latency of communications for the specific application or service, introducing delays that can disrupt the real-time interaction between the user and the application.

The generation of the blocking event can be based on predefined rules or policies that are uploaded or defined by an administrator. These rules may specify conditions under which the blocking event should be triggered, as well as the parameters for the degradation, such as the degree of bandwidth reduction or latency increase. Alternatively, the system may utilize one or more machine-learning models trained to identify network events and generate appropriate blocking events in response to these events. These models can analyze historical traffic data to learn patterns associated with specific applications and services, enabling the system to dynamically generate blocking events based on real-time traffic monitoring.

In some embodiments, one or more blocking event may include details such as the IP address and port number associated with the specific application or service, the duration for which the degradation should be applied, and any additional parameters required to enforce the traffic management policies. The system may also dynamically adjust the configuration of the blocking event based on real-time monitoring and analysis of network traffic patterns. This ensures that the blocking event remains effective and relevant as network conditions and traffic patterns evolve.

In some embodiments, the blocking event may specifically target applications such as messaging applications, with the intent that the degradation causes a specific message, such as a 2FA message, to be routed back to SMS instead of OTT services. By degrading the network traffic for the messaging application, the system ensures that messages like 2FA codes are delivered via SMS channels.

The system is configured to integrate with one or more network components as discussed herein to implement the blocking event. This may involve communicating with firewalls, traffic management systems, or other external systems capable of enforcing the traffic degradation policies. The blocking event may be propagated to these components, ensuring that the network traffic associated with the specific application or service is effectively degraded according to the defined parameters.

Additionally, the blocking event may be dynamically adjusted based on real-time monitoring of network traffic. For example, if the system detects changes in the communication patterns or network conditions, it may modify the degree of bandwidth reduction or latency increase to ensure that the traffic degradation remains effective.

In some embodiments, method 700 includes step 740, implementing, by one or more processors, the blocking event by instructing one or more network components to degrade the network traffic related to the specific application or service. The degradation of communication quality is configured to occur over a predefined temporal period.

The system is configured to communicate with various network components such as firewalls, traffic management systems, or other external systems capable of enforcing traffic degradation policies. The system sends instructions to these network components, specifying the details of the blocking event, including the IP address, port number, one or more applications, and/or the duration for which the degradation should be applied.

The methods of degradation may vary based on the requirements of the specific application or service. One method involves reducing the bandwidth available to the specific application or service, thereby limiting the data transfer rate and reducing the application's performance. Another method involves increasing the latency of communications for the specific application or service, introducing delays that disrupt the real-time interaction between the user and the application. Additionally, the system may block specific traffic flows entirely, such as outbound traffic on given ports, to terminate connections and ensure the degradation is applied to the intended traffic.

In some embodiments, the system is configured to dynamically adjust the degradation of communication quality based on real-time monitoring of network traffic. This dynamic adjustment is configured such that the blocking event remains effective and relevant as network conditions and communication patterns evolve. The degree of degradation may be modified in response to changes in the detected communication patterns, allowing the system to maintain optimal performance while enforcing the desired traffic management policies.

In some embodiments, the system is configured such that the blocking event is implemented in a manner that minimally impacts other network services and users not associated with the specific application or service. This is achieved by specifically selecting the traffic flows to be degraded, such as flows associated with a specific user and/or a specific application, and by continuously monitoring the impact of the blocking event. The system maintains logs of all blocking events and adjustments made, providing a record for analysis and future improvements.

In some embodiments, the system may implement transient degradation, where the blocking event is applied for a predefined temporal period and then reversed to restore normal communication quality. The system tracks the duration of the blocking event and automatically applies inverse rules after the specified period to resume normal network traffic conditions. This approach ensures that the degradation is temporary and that normal service is restored promptly after the blocking event has served its purpose.

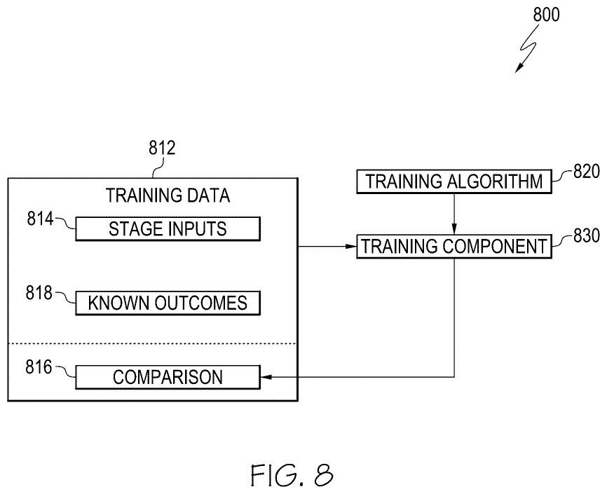

One or more implementations disclosed herein include and/or are implemented using a machine-learning model. For example, one or more of the components of environment 100 are implemented using a machine-learning model and/or are used to train the machine-learning model. FIG. 8 shows an example machine-learning training flow chart, according to some embodiments of the disclosure. Referring to FIG. 8, a given machine-learning model is trained using the training flow chart 800. The training data 812 includes one or more of stage inputs 814 and the known outcomes 818 related to the machine-learning model to be trained. The stage inputs 814 are from any applicable source including text, visual representations, data, values, comparisons, and stage outputs, e.g., one or more outputs from one or more steps from FIGS. 2A-7. The known outcomes 818 are included for the machine-learning models generated based on supervised or semi-supervised training, or can based on known labels, such as topic labels. An unsupervised machine-learning model is not trained using the known outcomes 818. The known outcomes 818 includes known or desired outputs for future inputs similar to or in the same category as the stage inputs 814 that do not have corresponding known outputs.

The training data 812 and a training algorithm 820, e.g., one or more of the modules implemented using the machine-learning model and/or are used to train the machine-learning model, is provided to a training component 830 that applies the training data 812 to the training algorithm 820 to generate the machine-learning model. According to an implementation, the training component 830 is provided comparison results 816 that compare a previous output of the corresponding machine-learning model to apply the previous result to re-train the machine-learning model. The comparison results 816 are used by the training component 830 to update the corresponding machine-learning model. The training algorithm 820 utilizes machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like.

The machine-learning model used herein is trained and/or used by adjusting one or more weights and/or one or more layers of the machine-learning model. For example, during training, a given weight is adjusted (e.g., increased, decreased, removed) based on training data or input data. Similarly, a layer is updated, added, or removed based on training data/and or input data. The resulting outputs are adjusted based on the adjusted weights and/or layers.

In general, any process or operation discussed in this disclosure is understood to be computer-implementable, such as the process illustrated in FIGS. 2A-7, are performed by one or more processors of a computer system as described herein. A process or process step performed by one or more processors is also referred to as an operation. The one or more processors are configured to perform such processes by having access to instructions (e.g., software or computer-readable code) that, when executed by one or more processors, cause one or more processors to perform the processes. The instructions are stored in a memory of the computer system. A processor is a central processing unit (CPU), a graphics processing unit (GPU), or any suitable type of processing unit.

A computer system, such as a system or device implementing a process or operation in the examples above, includes one or more computing devices. One or more processors of a computer system are included in a single computing device or distributed among a plurality of computing devices. One or more processors of a computer system are connected to a data storage device. A memory of the computer system includes the respective memory of each computing device of the plurality of computing devices.

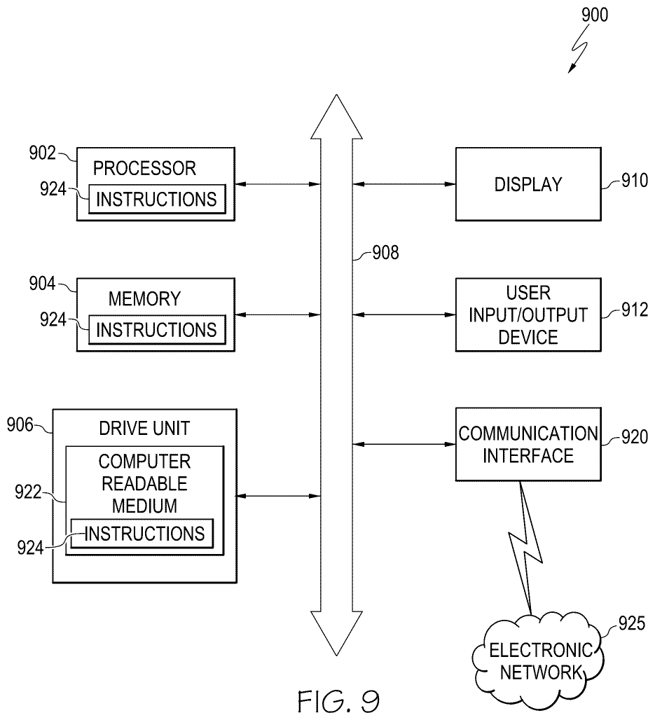

FIG. 9 illustrates an implementation of a computer system that executes techniques presented herein. The computer system 900 includes a set of instructions that are executed to cause the computer system 900 to perform any one or more of the methods or computer based functions disclosed herein. The computer system 900 operates as a standalone device or is connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, “analyzing,” or the like, refer to the action and/or processes of a computer or computing system, or similar electronic computing device, which manipulate and/or transform data represented as physical, such as electronic, quantities into other data similarly represented as physical quantities.

In a similar manner, the term “processor” refers to any device or portion of a device that processes electronic data, e.g., from registers and/or memory to transform that electronic data into other electronic data that, e.g., is stored in registers and/or memory. A “computer,” a “computing machine,” a “computing platform,” a “computing device,” or a “server” includes one or more processors.

In a networked deployment, the computer system 900 operates in the capacity of a server or as a client user computer in a server-client user environment, or as a peer computer system in a peer-to-peer (or distributed) environment. The computer system 900 is also implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 900 is implemented using electronic devices that provide voice, video, or data communication. Further, while the computer system 900 is illustrated as a single system, the term “system” shall also be taken to include any collection of systems or sub-systems that individually or jointly execute a set, or multiple sets, of instructions to perform one or more computer functions.

As illustrated in FIG. 9, the computer system 900 includes a processor 902, e.g., a central processing unit (CPU), a graphics processing unit (GPU), or both. The processor 902 is a component in a variety of systems. For example, the processor 902 is part of a standard personal computer or a workstation. The processor 902 is one or more processors, digital signal processors, application specific integrated circuits, field programmable gate arrays, servers, networks, digital circuits, analog circuits, combinations thereof, or other now known or later developed devices for analyzing and processing data. The processor 902 implements a software program, such as code generated manually (i.e., programmed).

The computer system 900 includes a memory 904 that communicates via bus 908. The memory 904 is a main memory, a static memory, or a dynamic memory. The memory 904 includes, but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 904 includes a cache or random-access memory for the processor 902. In alternative implementations, the memory 904 is separate from the processor 902, such as a cache memory of a processor, the system memory, or other memory. The memory 904 is an external storage device or database for storing data. Examples include a hard drive, compact disc (“CD”), digital video disc (“DVD”), memory card, memory stick, floppy disc, universal serial bus (“USB”) memory device, or any other device operative to store data. The memory 904 is operable to store instructions executable by the processor 902. The functions, acts, or tasks illustrated in the figures or described herein are performed by the processor 902 executing the instructions stored in the memory 904. The functions, acts, or tasks are independent of the particular type of instruction set, storage media, processor, or processing strategy and are performed by software, hardware, integrated circuits, firmware, micro-code, and the like, operating alone or in combination. Likewise, processing strategies include multiprocessing, multitasking, parallel processing, and the like.

As shown, the computer system 900 further includes a display 910, such as a liquid crystal display (LCD), an organic light emitting diode (OLED), a flat panel display, a solid-state display, a cathode ray tube (CRT), a projector, a printer or other now known or later developed display device for outputting determined information. The display 910 acts as an interface for the user to see the functioning of the processor 902, or specifically as an interface with the software stored in the memory 904 or in the drive unit 906.

Additionally or alternatively, the computer system 900 includes an input/output device 912 configured to allow a user to interact with any of the components of the computer system 900. The input/output device 912 is a number pad, a keyboard, a cursor control device, such as a mouse, a joystick, touch screen display, remote control, or any other device operative to interact with the computer system 900.

The computer system 900 also includes the drive unit 906 implemented as a disk or optical drive. The drive unit 906 includes a computer-readable medium 922 in which one or more sets of instructions 924, e.g. software, is embedded. Further, the sets of instructions 924 embodies one or more of the methods or logic as described herein. The sets of instructions 924 resides completely or partially within the memory 904 and/or within the processor 902 during execution by the computer system 900. The memory 904 and the processor 902 also include computer-readable media as discussed above.

In some systems, computer-readable medium 922 includes the set of instructions 924 or receives and executes the set of instructions 924 responsive to a propagated signal so that a device connected to network 925 communicates voice, video, audio, images, or any other data over the network 925. Further, the sets of instructions 924 are transmitted or received over the network 925 via the communication port or interface 920, and/or using the bus 908. The communication port or interface 920 is a part of the processor 902 or is a separate component. The communication port or interface 920 is created in software or is a physical connection in hardware. The communication port or interface 920 is configured to connect with the network 925, external media, the display 910, or any other components in the computer system 900, or combinations thereof. The connection with the network 925 is a physical connection, such as a wired Ethernet connection, or is established wirelessly as discussed below. Likewise, the additional connections with other components of the computer system 900 are physical connections or are established wirelessly. The network 925 alternatively be directly connected to the bus 908.

While the computer-readable medium 922 is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding, or carrying a set of instructions for execution by a processor or that causes a computer system to perform any one or more of the methods or operations disclosed herein. The computer-readable medium 922 is non-transitory, and may be tangible.

The computer-readable medium 922 includes a solid-state memory such as a memory card or other package that houses one or more non-volatile read-only memories. The computer-readable medium 922 is a random-access memory or other volatile re-writable memory. Additionally or alternatively, the computer-readable medium 922 includes a magneto-optical or optical medium, such as a disk or tapes or other storage device to capture carrier wave signals such as a signal communicated over a transmission medium. A digital file attachment to an e-mail or other self-contained information archive or set of archives is considered a distribution medium that is a tangible storage medium. Accordingly, the disclosure is considered to include any one or more of a computer-readable medium or a distribution medium and other equivalents and successor media, in which data or instructions are stored.

In an alternative implementation, dedicated hardware implementations, such as application specific integrated circuits, programmable logic arrays, and other hardware devices, is constructed to implement one or more of the methods described herein. Applications that include the apparatus and systems of various implementations broadly include a variety of electronic and computer systems. One or more implementations described herein implement functions using two or more specific interconnected hardware modules or devices with related control and data signals that are communicated between and through the modules, or as portions of an application-specific integrated circuit. Accordingly, the present system encompasses software, firmware, and hardware implementations.

Computer system 900 is connected to the network 925. The network 925 defines one or more networks including wired or wireless networks. The wireless network is a cellular telephone network, a 902.10, 902.16, 902.20, or WiMAX network. Further, such networks include a public network, such as the Internet, a private network, such as an intranet, or combinations thereof, and utilizes a variety of networking protocols now available or later developed including, but not limited to TCP/IP based networking protocols. The network 925 includes wide area networks (WAN), such as the Internet, local area networks (LAN), campus area networks, metropolitan area networks, a direct connection such as through a Universal Serial Bus (USB) port, or any other networks that allows for data communication. The network 925 is configured to couple one computing device to another computing device to enable communication of data between the devices. The network 925 is generally enabled to employ any form of machine-readable media for communicating information from one device to another. The network 925 includes communication methods by which information travels between computing devices. The network 925 is divided into sub-networks. The sub-networks allow access to all of the other components connected thereto or the sub-networks restrict access between the components. The network 925 is regarded as a public or private network connection and includes, for example, a virtual private network or an encryption or other security mechanism employed over the public Internet, or the like.

In accordance with various implementations of the present disclosure, the methods described herein are implemented by software programs executable by a computer system. Further, in an example, non-limited implementation, implementations can include distributed processing, component/object distributed processing, and parallel processing. Alternatively, virtual computer system processing can be constructed to implement one or more of the methods or functionality as described herein.

Although the present specification describes components and functions that are implemented in particular implementations with reference to particular standards and protocols, the disclosure is not limited to such standards and protocols. For example, standards for Internet and other packet switched network transmission (e.g., TCP/IP, UDP/IP, HTML, and HTTP) represent examples of the state of the art. Such standards are periodically superseded by faster or more efficient equivalents having one or more of the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure is implemented using any appropriate techniques for implementing the functionality described herein. The disclosure is not limited to any particular programming language or operating system.

It should be appreciated that in the above description of example embodiments of the disclosure, various features of the disclosure are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed disclosure requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the instructions for carrying out such a method or element of a method forms a means for carrying out the method or element of a method. Furthermore, an element described herein of an apparatus embodiment is an example of a means for carrying out the function performed by the element for the purpose of carrying out the disclosure.

In the description provided herein, numerous specific details are set forth. However, it is understood that embodiments of the disclosure are practiced without these specific details. In other instances, well-known methods, structures and techniques have not been shown in detail in order not to obscure an understanding of this description.

Thus, while there has been described what are believed to be the preferred embodiments of the disclosure, those skilled in the art will recognize that other and further modifications are made thereto without departing from the spirit of the disclosure, and it is intended to claim all such changes and modifications as falling within the scope of the disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method for degrading communication traffic, the method comprising:
monitoring, by one or more processors, a network traffic associated with one or more devices;
detecting, by the one or more processors, a predefined communication pattern in the monitored network traffic;
upon detecting the predefined communication pattern, generating a blocking event, the blocking event configured to degrade the network traffic associated with a specific application or service; and
implementing the blocking event by instructing one or more network components to degrade the network traffic associated with the specific application or service, wherein the degradation reduces a communication quality over a predefined temporal period.

2. The computer-implemented method of claim 1, wherein the monitoring further comprises analyzing metadata associated with the network traffic to identify the predefined communication pattern, wherein the metadata includes one or more of: one or more domain names; one or more IP addresses; and one or more timestamps associated with the network traffic.

3. The computer-implemented method of claim 1, wherein the predefined communication pattern comprises a sequence of network addresses accessed by the one or more devices, and the sequence of network addresses is identified by analyzing an order and frequency of network addresses accessed within a specified time frame.

4. The computer-implemented method of claim 1, wherein detecting the predefined communication pattern comprises: identifying the predefined communication pattern based on a temporal correlation of network traffic events.

5. The computer-implemented method of claim 1, wherein the blocking event is configured to degrade the network traffic by reducing a bandwidth available to the specific application or service.

6. The computer-implemented method of claim 1, wherein the blocking event is configured to degrade the network traffic by increasing a latency of communications for the specific application or service.

7. The computer-implemented method of claim 1, further comprising: generating an alert in response to detecting the predefined communication pattern, wherein the alert includes one or more details of the detected predefined communication pattern and the one or more associated device.

8. The computer-implemented method of claim 1, further comprising: dynamically adjusting the degradation of the communication quality based on real-time monitoring of the network traffic, wherein a degree of degradation is modified in response to changes in the detected predefined communication pattern.

9. The computer-implemented method of claim 1, further comprising: identifying the specific application based on a destination IP address and a port number associated with the network traffic, wherein the identified specific application is used to apply an appropriate blocking event.

10. A system comprising memory and one or more processors communicatively coupled to the memory, the one or more processors configured to:
monitor a network traffic associated with one or more devices;
detect a predefined communication pattern in the monitored network traffic;
upon detecting the predefined communication pattern, generate a blocking event, the blocking event configured to degrade the network traffic associated with a specific application or service; and
implement the blocking event by instructing one or more network components to degrade the network traffic associated with the specific application or service, wherein the degradation reduces a communication quality over a predefined temporal period.

11. The system of claim 10, wherein the one or more processors are further configured to analyze metadata associated with the network traffic to identify the predefined communication patterns, wherein the metadata includes one or more of one or more domain names, one or more IP addresses, and one or more timestamps associated with the network traffic.

12. The system of claim 10, wherein the predefined communication pattern comprises a sequence of network addresses accessed by the one or more devices, and the sequence of network addresses is identified by analyzing an order and frequency of network addresses accessed within a specified time frame.

13. The system of claim 10, wherein the one or more processors are further configured to: identify the predefined communication pattern based on a temporal correlation of network traffic events.

14. The system of claim 10, wherein the blocking event is configured to degrade the network traffic by reducing a bandwidth available to the specific application or service.

15. The system of claim 10, wherein the blocking event is configured to degrade the network traffic by increasing a latency of communications for the specific application or service.

16. The system of claim 10, wherein the one or more processors are further configured to generate an alert in response to detecting the predefined communication pattern, wherein the alert includes one or more details of the detected predefined communication pattern and the one or more associated device.

17. The system of claim 10, wherein the one or more processors are further configure to dynamically adjust the degradation of the communication quality based on real-time monitoring of the network traffic, wherein a degree of degradation is modified in response to changes in the detected predefined communication patterns.

18. The system of claim 10, wherein the one or more processors are further configured to identify the specific application or service based on a destination IP address and a port number associated with the network traffic, wherein the identified specific application is used to apply an appropriate blocking event.

19. One or more non-transitory computer-readable storage media including instructions that, when executed by one or more processors, cause the one or more processors to:
monitor a network traffic associated with one or more devices;
detect a predefined communication pattern in the monitored network traffic;
upon detecting the predefined communication pattern, generate a blocking event, the blocking event configured to degrade the network traffic associated with a specific application or service; and
implement the blocking event by instructing one or more network components to degrade the network traffic associated with the specific application or service, wherein the degradation reduces a communication quality over a predefined temporal period.

20. The one or more non-transitory computer-readable storage media of claim 19, wherein the instructions, when executed by the one or more processors, further cause the one or more processors to:
analyze metadata associated with the network traffic to identify the predefined communication pattern, wherein the metadata includes one or more of: one or more domain names; one or more IP addresses; and one or more timestamps associated with the network traffic;
dynamically adjust the degradation of the communication quality based on real-time monitoring of the network traffic, wherein a degree of degradation is modified in response to changes in the detected predefined communication pattern; and
identify the specific application or service based on a destination IP address and a port number associated with the network traffic, and apply an appropriate blocking event based on the identified specific application or service.
